(19) United States
(12) Patent Application Publication
(10) Pub. No.: US 2010/0010983 A1
(43) Pub. Date: Jan. 14, 2010

(54) AUTOMATED DICOM PRE-FETCH APPLICATION

(75) Inventor: Kevin M. CRUCS, Copley, OH (US)

Correspondence Address: HAHN LOESER & PARKS, LLP, One GOJO Plaza, Suite 300, AKRON, OH, 44311-1076, US

(73) Assignee: APTERYX, INC., Akron, OH (US)

(21) Appl. No.: 12/171,618

(22) Filed: Jul. 11, 2008

(51) Int. Cl. G06F 17/30; G06F 7/00

(52) U.S. Cl. 707/5; 707/104.1; 707/E17.005; 707/E17.019; 707/E17.014

(57) ABSTRACT

Systems, methods, and computer readable medium for pre-fetching patient information using a DICOM protocol. A DICOM pre-fetch application communicates with a patient appointment application to retrieve upcoming patient appointment information. An external DICOM database server is queried, directly or indirectly, by the DICOM pre-fetch application to determine any medical image information stored on the external DICOM database server that is associated with the patient appointment information. The DICOM pre-fetch application retrieves the medical image information from the external DICOM database server and stores the medical image information on a local DICOM database server.

### TECHNICAL FIELD

Certain embodiments of the present invention relate to DICOM query/retrieve operations. More particularly, certain embodiments relate to a 3^{rd} party application that automatically and transparently determines or anticipates patient appointments and retrieves related stored patient information via a DICOM query/retrieve protocol in response to the determination or anticipation.

### BACKGROUND

Digital Imaging and Communications in Medicine (DICOM) is a well-known standard for transferring images and associated information between devices manufactured by various vendors. Typically, a DICOM database server is used to store, organize, and manage medical images. Various external systems may desire to communicate with a DICOM database server to store images to the DICOM database server and/or to retrieve images from the DICOM database server by submitting image requests to the DICOM database server.

However, the DICOM standard provides for more than the transferring and storing of digital medical images. Other DICOM functions include media storage, query/retrieve, worklist query, make image hard copies, study and results management, print management, worklist management, and test connectivity verification.

A basic concept used in the DICOM standard is that of “Services on Objects”. An example of an “object” is an X-ray image. Two examples of a “service” are the “query/retrieve” and “store” functions. In the DICOM standard, processes of operating on objects are called “Service Object Pair Classes” (SOP Classes). Examples of SOP Classes include “store an X-ray image”, “print an X-ray image”, and “retrieve a worklist”.

Unique Identifiers (UID's) are determined for SOP classes and are also applied to studies, series, and images. A patient study includes a study component such as, for example, an examination using a particular type of medical imaging machine. The images that are captured in sequence during the study on a patient form a series of objects.

The DICOM standard is founded on a client/server concept. A device that uses a service is the client device, and the device that provides the service is the server device. The client device is called a Service Class User (SCU). The server device is called a Service Class Provider (SCP). An SCU transmits a Service Request to an SCP over a network. The SCP transmits back a response to the SCU over the network. For information to be transferred between a SCP and a SCU, a communication syntax (e.g., a DICOM protocol) must be agreed upon and association between the SCU and the SCP must be opened.

The DICOM standard facilitates communication of digital medical images of various types including X-ray, computerized tomography, magnetic resonance, and ultrasound, for example. DICOM activities are administered in a queued manner via application software running on a host computer. The host computer may be an integral part of a medical imaging machine, for example, or a workstation in a medical office.

A PACS (Picture Archive and Communication System) is an image management system typically used in a radiology department of a healthcare facility such as a hospital or a doctor's office, for example. A PACS system may manage the details of imaging related tasks within a facility including acquisitions, archiving, manipulation, and display. A PACS system may be implemented in the form of a local DICOM database server and a database, for example.

A DICOM client typically needs to know which DICOM database server to select and query, depending on the information that is being requested. In amorphous environments having many clients and where, for example, hospitals are associating with dental clinics, managing and administering sources of information for each DICOM client can be overwhelming.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

A first embodiment of the present invention comprises a method for pre-fetching patient information using a DICOM protocol. The method comprises:
(a) communicating with a medical appointment application having patient appointment information corresponding to at least one upcoming patient appointment;
(b) receiving the patient appointment information via said communicating;
(c) querying a local DICOM database server to determine any first medical image information stored on the local DICOM database server that is associated with the patient appointment information, using a DICOM protocol;
(d) querying at least one external DICOM database server to determine any second medical image information stored on the at least one external DICOM database server that is associated with the patient appointment information, using the DICOM protocol;
(e) comparing the first medical image information to the second medical image information; and
(f) retrieving third medical image information from the at least one external DICOM database server, based on the comparing, and storing the third medical image information on the local DICOM database server, using the DICOM protocol.

The method steps may be performed by a DICOM pre-fetch software application residing on and operating on a personal computer, for example.

The patient appointment information may include at least one of a specified patient identification number, a specified appointment date and time, a specified date range, patient demographic information, and a specified type of image information. When a date range is not specified, then all dates are considered. The retrieving and storing of the third medical image information may further be based on a time of day, a work load of the local DICOM database server, a work load of the at least one external DICOM database server, a bandwidth limitation, an appointment date and time specified in the patient appointment information, a date range specified in the patient appointment information, or a type of image information specified in the patient appointment information.

The method may further comprise accessing at least a portion of the first medical image information and the third medical image information from the local DICOM database server via a workstation during the at least one patient appointment. The method may also comprise deleting the first medical image information and the third medical image information from the local DICOM database server after the at least one patient appointment has occurred.

The method step of querying a local DICOM database server and the method step of querying at least one external DICOM database server may be performed by a DICOM pre-fetch software application residing on and operating on a personal computer, for example, interfacing to the local DICOM database server via a local network and interfacing to the at least one external DICOM database server via an external network.

As an alternative, the method step of querying a local DICOM database server may be performed by a DICOM pre-fetch software application residing on and operating on, for example, a personal computer interfacing to the local DICOM database server via a local network. The method step of querying at least one external DICOM database server may be performed by the DICOM pre-fetch software application via the local DICOM database server functioning as a DICOM query bridging server (DQBS) and interfacing to the at least one external DICOM database server via an external network.

Another embodiment of the present invention comprises a computer readable medium having encoded thereon computer executable instructions for performing a method for pre-fetching patient information using a DICOM protocol. The method comprises:
(a) communicating with a medical appointment application having patient appointment information corresponding to at least one upcoming patient appointment;
(b) receiving the patient appointment information via said communicating;
(c) querying a local DICOM database server to determine any first medical image information stored on the local DICOM database server that is associated with the patient appointment information, using a DICOM protocol;
(d) querying at least one external DICOM database server to determine any second medical image information stored on the at least one external DICOM database server that is associated with the patient appointment information, using the DICOM protocol;
(e) comparing the first medical image information to the second medical image information; and
(f) retrieving third medical image information from the at least one external DICOM database server, based on the comparing, and storing the third medical image information on the local DICOM database server, using the DICOM protocol.

The patient appointment information may include at least one of a specified patient identification number, patient demographic information, a specified appointment date and time, a specified date range, and a specified type of image information. The retrieving and storing of the third medical image information may further be based on a time of day, a work load of the local DICOM database server, a work load of the at least one external DICOM database server, a bandwidth limitation, an appointment date and time specified in the patient appointment information, a date range specified in the patient appointment information, or a type of image information specified in the patient appointment information.

The method may further comprise deleting the first medical image information and the third medical image information from the local DICOM database server after the at least one patient appointment has occurred.

A further embodiment of the present invention comprises a system for pre-fetching patient information using a DICOM protocol. The system comprises a personal computer, a local DICOM database server operationally interfacing to the personal computer via a local network, at least one external DICOM database server operationally interfacing to the personal computer via an external network, and at least one work station operationally interfacing to the local DICOM database server via the local network. The personal computer includes a medical appointment software application for making patient appointments, and a DICOM pre-fetch software application for:
(a) communicating with the medical appointment application having patient appointment information corresponding to at least one upcoming patient appointment;
(b) receiving the patient appointment information via said communicating;
(c) querying the local DICOM database server to determine any first medical image information stored on the local DICOM database server that is associated with the patient appointment information, using a DICOM protocol;
(d) querying the at least one external DICOM database server to determine any second medical image information stored on the at least one external DICOM database server that is associated with the patient appointment information, using the DICOM protocol;
(e) comparing the first medical image information to the second medical image information; and
(f) retrieving third medical image information from the at least one external DICOM database server, based on the comparing, and storing the third medical image information on the local DICOM database server, using the DICOM protocol.

Another embodiment of the present invention comprises a system for pre-fetching patient information using a DICOM protocol. The system comprises a personal computer, a local DICOM database server operationally interfacing to the personal computer via a local network, at least one external DICOM database server operationally interfacing to the local DICOM database server via an external network, and at least one work station operationally interfacing to the local DICOM database server via the local network. The personal computer includes a medical appointment software application for making patient appointments, and a DICOM pre-fetch software application for:
(a) communicating with the medical appointment application having patient appointment information corresponding to at least one upcoming patient appointment;
(b) receiving the patient appointment information via said communicating;
(c) querying the local DICOM database server to determine any first medical image information stored on the local DICOM database server that is associated with the patient appointment information, using a DICOM protocol;
(d) querying the at least one external DICOM database server, via the local DICOM database server functioning as a DQBS, to determine any second medical image information stored on the at least one external DICOM database server that is associated with the patient appointment information, using the DICOM protocol;
(e) comparing the first medical image information to the second medical image information; and
(f) retrieving third medical image information from the at least one external DICOM database server, based on the comparing, and storing the third medical image information on the local DICOM database server, using the DICOM protocol.

A further embodiment of the present invention comprises a method for pre-fetching patient information using a DICOM protocol. The method comprises:
(a) communicating with a medical appointment application having patient appointment information corresponding to at least one upcoming patient appointment;
(b) receiving the patient appointment information via said communicating;
(c) querying at least one external DICOM database server to determine any medical image information stored on the at least one external DICOM database server that is associated with the patient appointment information, using the DICOM protocol;
(d) retrieving the medical image information from the at least one external DICOM database server; and
(e) storing the medical image information on the local DICOM database server, using the DICOM protocol.

The method steps may be performed by a DICOM pre-fetch software application residing on and operating on a personal computer, for example.

The patient appointment information may include at least one of a specified patient identification number, a specified appointment date and time, a specified date range, patient demographic information, and a specified type of image information. When a date range is not specified, then all dates are considered. The retrieving and storing of the medical image information may further be based on a time of day, a work load of the local DICOM database server, a work load of the at least one external DICOM database server, a bandwidth limitation, an appointment date and time specified in the patient appointment information, a date range specified in the patient appointment information, or a type of image information specified in the patient appointment information.

The method may further comprise accessing at least a portion of the medical image information from the local DICOM database server via a workstation during the at least one patient appointment. The method may also comprise deleting the medical image information from the local DICOM database server after the at least one patient appointment has occurred.

The method step of querying at least one external DICOM database server may be performed by a DICOM pre-fetch software application residing on and operating on a personal computer, for example, interfacing to the local DICOM database server via a local network and interfacing to the at least one external DICOM database server via an external network.

As an alternative, the method step of querying at least one external DICOM database server may be performed by the DICOM pre-fetch software application via the local DICOM database server functioning as a DICOM query bridging server (DQBS) and interfacing to the at least one external DICOM database server via an external network.

Another embodiment of the present invention comprises a computer readable medium having encoded thereon computer executable instructions for performing a method for pre-fetching patient information using a DICOM protocol. The method comprises:
(a) communicating with a medical appointment application having patient appointment information corresponding to at least one upcoming patient appointment;
(b) receiving the patient appointment information via said communicating;
(c) querying at least one external DICOM database server to determine any medical image information stored on the at least one external DICOM database server that is associated with the patient appointment information, using the DICOM protocol;
(d) retrieving the medical image information from the at least one external DICOM database server; and
(e) storing the medical image information on the local DICOM database server, using the DICOM protocol.

The patient appointment information may include at least one of a specified patient identification number, patient demographic information, a specified appointment date and time, a specified date range, and a specified type of image information. The retrieving and storing of the medical image information may further be based on a time of day, a work load of the local DICOM database server, a work load of the at least one external DICOM database server, a bandwidth limitation, an appointment date and time specified in the patient appointment information, a date range specified in the patient appointment information, or a type of image information specified in the patient appointment information.

The method may further comprise deleting the medical image information from the local DICOM database server after the at least one patient appointment has occurred.

A further embodiment of the present invention comprises a system for pre-fetching patient information using a DICOM protocol. The system comprises a personal computer, a local DICOM database server operationally interfacing to the personal computer via a local network, at least one external DICOM database server operationally interfacing to the personal computer via an external network, and at least one work station operationally interfacing to the local DICOM database server via the local network. The personal computer includes a medical appointment software application for making patient appointments, and a DICOM pre-fetch software application for:
(a) communicating with the medical appointment application having patient appointment information corresponding to at least one upcoming patient appointment;
(b) receiving the patient appointment information via said communicating;
(c) querying the at least one external DICOM database server to determine any medical image information stored on the at least one external DICOM database server that is associated with the patient appointment information, using the DICOM protocol;
(d) retrieving the medical image information from the at least one external DICOM database server; and
(e) storing the medical image information on the local DICOM database server, using the DICOM protocol.

Another embodiment of the present invention comprises a system for pre-fetching patient information using a DICOM protocol. The system comprises a personal computer, a local DICOM database server operationally interfacing to the personal computer via a local network, at least one external DICOM database server operationally interfacing to the local DICOM database server via an external network, and at least one work station operationally interfacing to the local DICOM database server via the local network. The personal computer includes a medical appointment software application for making patient appointments, and a DICOM pre-fetch software application for:
(a) communicating with the medical appointment application having patient appointment information corresponding to at least one upcoming patient appointment;
(b) receiving the patient appointment information via said communicating;
(c) querying the at least one external DICOM database server, via the local DICOM database server functioning as a DQBS, to determine any medical image information stored on the at least one external DICOM database server that is associated with the patient appointment information, using the DICOM protocol;
(d) retrieving the medical image information from the at least one external DICOM database server; and
(e) storing the medical image information on the local DICOM database server, using the DICOM protocol.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a schematic diagram of a first exemplary embodiment of a system for pre-fetching patient information using a DICOM protocol;

FIG. 2 illustrates a flowchart of a first exemplary embodiment of a method for pre-fetching patient information using a DICOM protocol and the system of FIG. 1;

FIG. 3 illustrates a schematic diagram illustrating the concept of a DICOM Query Bridging Server (DQBS).

FIG. 4 illustrates a schematic diagram of a second exemplary embodiment of a system for pre-fetching patient information using a DICOM protocol;

FIG. 5 illustrates a flowchart of a second exemplary embodiment of a method for pre-fetching patient information using a DICOM protocol and the system of FIG. 4;

FIG. 6 illustrates a flowchart of a third exemplary embodiment of a method for pre-fetching patient information using a DICOM protocol and the system of FIG. 2; and

FIG. 7 illustrates a flowchart of a fourth exemplary embodiment of a method for pre-fetching patient information using a DICOM protocol and the system of FIG. 4.

### DETAILED DESCRIPTION

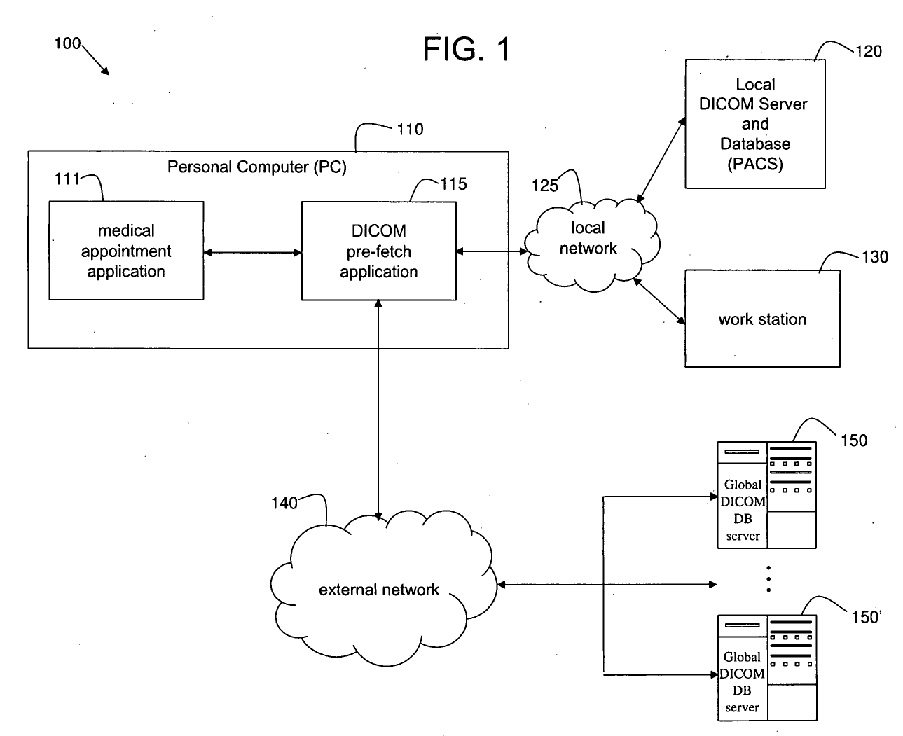

FIG. 1 illustrates a schematic diagram of a first exemplary embodiment of a system 100 for pre-fetching patient information using a DICOM protocol. As used herein, the term “DICOM protocol” refers generally to a communication protocol that follows the DICOM standard. The system includes a personal computer 110 or equivalent processor-based platform. The system 100 includes a medical appointment software application 111 residing on the personal computer 110 (e.g., in a memory of the personal computer) for making patient appointments. For example, a medical administrative person working in a local medical office may enter patient appointment information into the medical appointment software application 111 when making an appointment for a patient. The patient appointment information may include, for example, a specified patient identification number, a specified appointment date and time, a specified date range, and a specified type of image information. Other information, including the patient's name, age, and sex may be entered as well, for example (i.e., patient demographic information). The specified date range may correspond to a time interval over which a physician is interested, for example, in medical image information associated with the patient. The specified type of image information may correspond to, for example, a particular imaging modality such as one of ultrasound, MRI (magnetic resonance imaging), X-ray, etc.

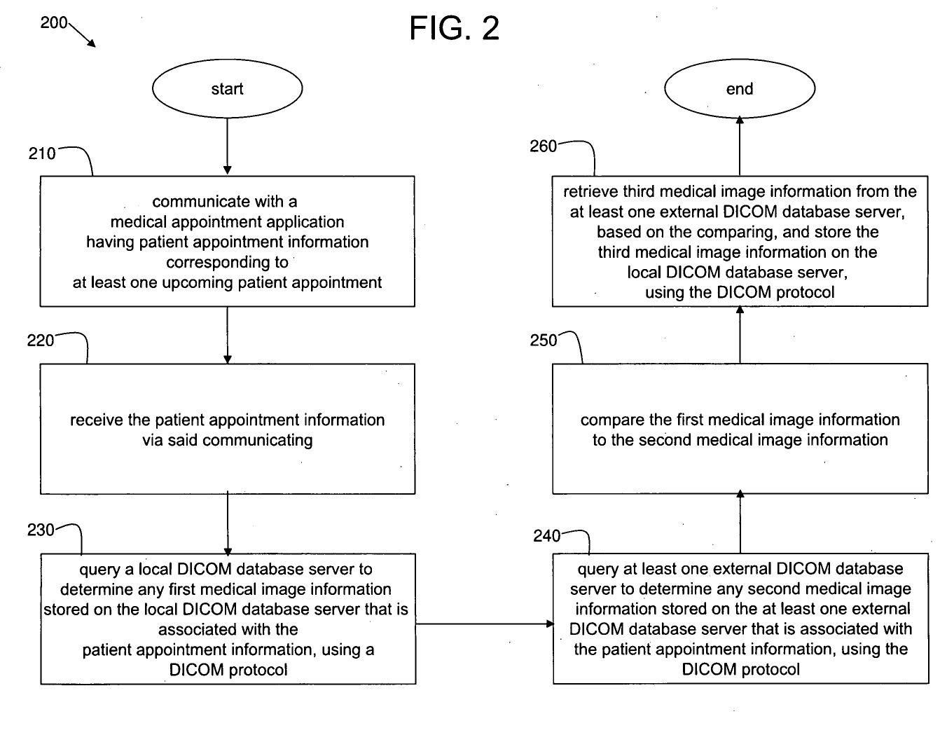

The system 100 also includes a DICOM pre-fetch software application 115 residing on the personal computer 110 (e.g., in a memory of the personal computer). The functionality provided by the DICOM pre-fetch software application 115 is described later herein with respect to the method 200 of FIG. 2. In general, however, the DICOM pre-fetch software application 115 retrieves patient appointment information ahead of time (i.e., before the scheduled patient appointment) from the medical appointment software application 111 and interacts with various DICOM database servers to retrieve desired medical image information associated with the patient such that the desired medical image information is locally available to the physician at the time of the scheduled patient appointment.

The medical appointment software application 111 may or may not be DICOM-compatible, in accordance with various embodiments of the present invention. If the medical appointment software application 111 is not DICOM compatible, then the DICOM pre-fetch software application 115 may have to be customized to communicate with the medical appointment software application 111. Otherwise, a standard DICOM protocol may be followed. When communicating with the medical appointment software application 111, the DICOM pre-fetch software application 115 may access an appointment database associated with the medical appointment software application 111, for example.

In accordance with certain embodiments, to initiate communication between the medical appointment software application 111 and the DICOM pre-fetch software application 115, the DICOM pre-fetch software application 115 may query the medical appointment software application 111 for patient appointment information. Alternatively, the medical appointment software application 111 may initiate communication by pushing patient appointment information to the DICOM pre-fetch software application 115.

The system 100 also includes a local DICOM database server 120 operationally interfacing to the personal computer 110 via a local network 125 (e.g., a local area network). The local DICOM database server 120 may serve as a PACS (Picture Archive and Communication System) as used in a radiology department of a healthcare facility such as a hospital or a doctor's office, for example. A PACS system may manage the details of imaging related tasks within a facility including acquisitions, archiving, manipulation, and display. As used herein, the term “DICOM database server” refers to a DICOM server and associated database(s). A DICOM database server is capable of storing and/or archiving at least medical image information.

The system 100 further includes a work station 130 operationally interfacing to the local DICOM database server 120 via the local network 125. The work station 130 may be used by a physician or other user to readily call up and view images stored on the local DICOM database server 120, for example, during an appointment with a patient. The system also includes at least one external DICOM database server 150 operationally interfacing to the personal computer 110 via an external network 140 (e.g., the Internet). An external DICOM database server 150, as discussed herein, corresponds to a global DICOM database server and is typically used to archive medical image information off site (i.e., remotely) away from the local medical facility where the personal computer 110 and the local DICOM database server 120 reside.

In accordance with an embodiment of the present invention, the DICOM pre-fetch software application 115 may be stored on a computer readable medium such as, for example, a compact disk (CD) for distribution. In accordance with other alternative embodiments of the present invention, the DICOM pre-fetch software application 115 may reside on another PC which operatively interfaces to the PC 110 via the local network 125, or may reside on the local DICOM database server 120, or on the work station 130, for example.

FIG. 2 illustrates a flowchart of a first exemplary embodiment of a method 200 for pre-fetching patient information using a DICOM protocol and the system 100 of FIG. 1. In step 210, communicate with a medical appointment application having patient appointment information corresponding to at least one upcoming patient appointment. In step 220, receive the patient appointment information via the communicating. In step 230, query a local DICOM database server to determine any first medical image information stored on the local DICOM database server that is associated with the patient appointment information, using a DICOM protocol. In step 240, query at least one external DICOM database server to determine any second medical image information stored on the at least one external DICOM database server that is associated with the patient appointment information, using the DICOM protocol. In step 250, compare the first medical image information to the second medical image information. In step 260, retrieve third medical image information from the at least one external DICOM database server, based on the comparing, and store the third medical image information on the local DICOM database server, using the DICOM protocol.

The following is an example of using the system 100 in accordance with the method 200. A radiologist may have previously archived X-ray images and ultrasound images (medical image information) of a particular patient (Mr. Jones) to the global DICOM database server 150. The ultrasound images and a first portion of the X-ray images were archived on Nov. 1, 2007. A second portion of the X-ray images were archived on May 19, 2008, about six months later. Furthermore, X-ray and ultrasound images associated with the same patient have been stored on the local DICOM database server 120 on Nov. 19, 2007, about six months earlier.

The patient has an appointment scheduled in the medical appointment software application 111 for May 30, 2008. On May 29, 2008, the DICOM pre-fetch software application 115 automatically queries the medical appointment software application 111 for any upcoming patient appointments and determines that Mr. Jones has an appointment scheduled for May 30, 2008 (i.e., the next day).

In order to prepare for the appointment of Mr. Jones, the DICOM pre-fetch software application 115 queries the local DICOM database server 120 to determine any first medical image information stored on the local DICOM server that is associated with Mr. Jones. As a result, the DICOM pre-fetch software application 115 finds the X-ray and ultrasound images that were stored to the local DICOM database server 120 on Nov. 19, 2007. Next, the DICOM pre-fetch software application 115 goes out via the external network 140 and queries at least one global DICOM database server 150 to determine any second medical image information stored on the global DICOM database server 150 that is associated with Mr. Jones. As a result, the DICOM pre-fetch software application 115 finds the previously archived ultrasound and X-ray images of Mr. Jones that were archived to the global DICOM database server 150 on Nov. 1, 2007 and May 19, 2008. As part of the query operations, the DICOM pre-fetch software application 115 may populate DICOM query fields with at least a portion of the patient appointment information.

The DICOM pre-fetch software application 115 then performs a comparison of the first medical image information stored on the local DICOM database server 120 and the second medical image information stored on the external DICOM database server 150 and determines that the ultrasound images and the first portion of the X-ray images on the external DICOM database server 150 are the same as the ultrasound images and the X-ray images stored on the local DICOM database server 120. The second portion of the X-ray images stored on the external DICOM database server 150 are more recent images that are not stored on the local DICOM database server 120.

The DICOM pre-fetch software application 115, as a result of the comparison, determines that the more recent medical image information (X-ray images) stored on the external DICOM database server 150 should be retrieved and stored to the local DICOM database server 120 such that the more recent medical image information will be locally available to a physician via the work station 130 at the time of Mr. Jones' appointment. In this example, the third medical image information to be retrieved is the second portion of the X-ray images stored on the global DICOM database server 150.

The DICOM pre-fetch software application 115 may or may not immediately begin retrieving the third medical image information from the external DICOM database server 150 after the comparison. The DICOM pre-fetch software application 115 may be programmed to retrieve the third medical image information at a certain time of day (e.g., in the middle of the night). Alternatively, the DICOM pre-fetch software application 115 may determine a work load of the local DICOM database server 120 and/or a work load of the external DICOM database server 150 and wait until the work load is below some pre-defined level before beginning to retrieve the third medical image information. Furthermore, a bandwidth limitation of the system 100 may affect how and when the third medical image information is retrieved. For example, the communication bandwidth between the personal computer 110 and a DICOM database server 150 may cause the third medical image information to be retrieved intermittently in small segments over several hours, for example.

If a date range is specified in the patient appointment information which includes the date of May 19, 2008 on which the third medical image information of Mr. Jones was archived to the external DICOM database server 150, then the medical image information may be retrieved. However, if the specified date range does not include May 19, 2008, then the medical image information may not be retrieved. Furthermore, if a type of medical image information is specified in the patient appointment information (e.g., X-ray type), then only the X-ray medical image information associated with Mr. Jones may be retrieved, and not any other type of medical image information which may also be associated with Mr. Jones.

When the appointment for Mr. Jones takes place on May 30, 2008, the X-ray medical image information retrieved from the external DICOM database server 150, as well as the X-ray and ultrasound medical image information previously stored on the local DICOM database server 120, is locally available for Mr. Jones' physician to access via the work station 130. In this manner, the physician may, for example, compare the more recent X-ray images of Mr. Jones with the previous X-ray images of Mr. Jones to determine, for example, if a previously diagnosed disease has spread or receded.

Sometime after the appointment of Mr. Jones is completed, the DICOM pre-fetch software application 115 may direct that, for example, the older X-ray images and the ultrasound images be deleted from the local DICOM database server 120, thus keeping only the more recent X-ray images locally. All of the medical image information associated with Mr. Jones may still be archived on the global DICOM database server 150 to be retrieved later, if desired.

Therefore, the DICOM pre-fetch software application 115 automatically interacts with the medical appointment software application 111 and the various local and external DICOM database servers, in a manner that is transparent to any users, to ensure that desired medical image information is available locally to a physician at the time of a patient appointment.

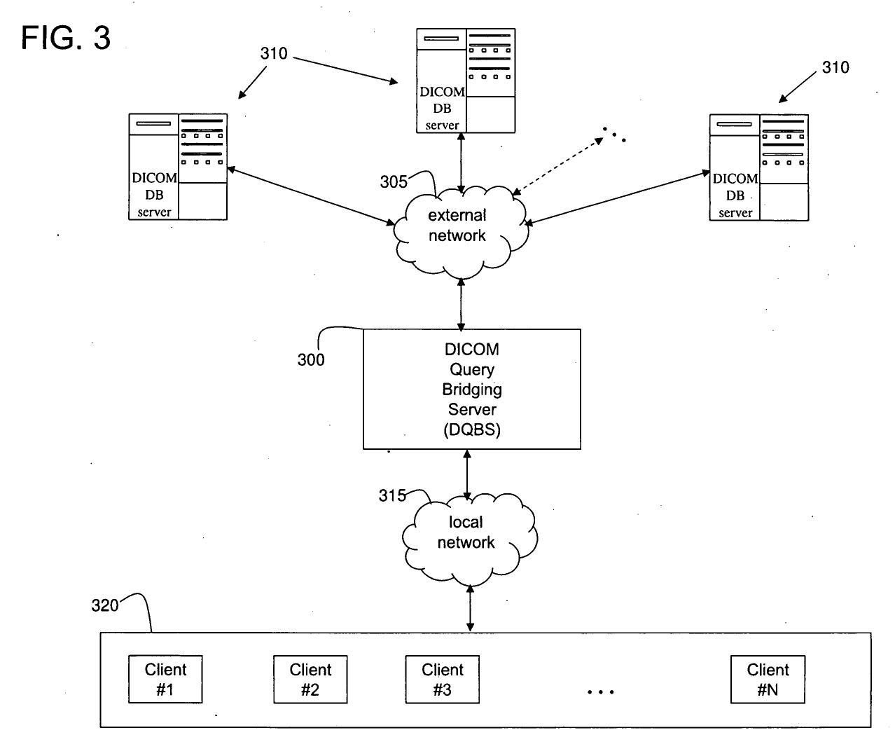

FIG. 3 illustrates a schematic diagram illustrating the concept of a DICOM Query Bridging Server (DQBS), which may be used in accordance with an embodiment of the present invention. FIG. 3 shows a DQBS 300 interfacing to a plurality of external DICOM database servers 310 via an external network 305, and a plurality of client computers 320 via a local network 315. The DQBS 300 functions as a gatekeeper or bridge between the clients 320 and the external or global DICOM database servers 310. As an alternative, the clients 320 may interface to the DQBS 300 via the external network 305.

A client 320 may make a request to the DQBS 300 (e.g., a DICOM query). The DQBS 300 may then forward the request to at least one of the global DICOM database servers 310 via the external network 305 (e.g., the Internet). For example, the request may be forwarded to an appropriate external DICOM database server 310 based on a look-up table in the DQBS 300. Alternatively, the DQBS 300 may forward the request to each of the external DICOM database servers 310 one at a time until the DQBS 300 receives a return acknowledgement from one of the external DICOM database servers 310.

As a further alternative, the DQBS 300 may perform load balancing. The DQBS 300 may sense the work load of each external DICOM database server 310, where each external DICOM database server 310 points to the same database. The DQBS 300 may then forward the request to the external DICOM database server 310 having the smallest work load (i.e., that external DICOM database server 310 which is least busy).

From the client side, it appears that just one DICOM server is being used (i.e., the DQBS 300). The client 320 does not have to select a different server each time the client performs a DICOM query. Instead, the client 320 always queries the DQBS 300 and lets the DQBS 300 determine how and where to forward the query. The DQBS 300 requires only one entry point. A client 320 does not need a separate entry point (e.g., IP address, AE title) for each external DICOM database server 310. All of the logic and smarts of how and where to forward a query resides in the DQBS 300.

The DQBS 300 functions as an intermediary with one entry point. The clients 320 contact the DQBS 300 and the DQBS 300 contacts the other external DICOM database servers 310 according to some pre-programmed logic or strategy set up by an IT department. The IT staff sets up and maintains the DQBS 300 and all the logic and mappings for routing. The DQBS 300 may query multiple external DICOM database servers 310 or may have specific look-up terms based on heuristics, a specification, a region, or an imaging modality, for example, resulting in the querying of a particular external DICOM database server 310. In general, the DQBS 300 makes routing easier from an administrative stand point since the DQBS 300 dictates how the data infrastructure works and the clients 320 do not have to worry about this. Otherwise, each client 320 would have to be set up to send requests to the appropriate DICOM servers 310.

Any client 320 may contact the DQBS 300 as if the DQBS 300 is a standard DICOM database server. Then the DQBS 300 may handle any of a myriad of different possible set-up configurations. Such set-up configurations may entail load balancing, multiple-tiered databases, non-replicated database queries against multiple DICOM servers, storage-specific requirements specified in the client query (e.g., regions, doctors, modalities such as dental where a dental DICOM server is queried, or medical where a medical PACS is queried).

In amorphous environments where, for example, hospitals are associating with dental clinics, the clients 320 may use any standard 3rd party DICOM querying application to communicate with the DQBS 300. The plurality of external DICOM database servers 310 may include primary servers and secondary back-up servers, and the DQBS 300 may be configured to know what information is stored on which servers, for example.

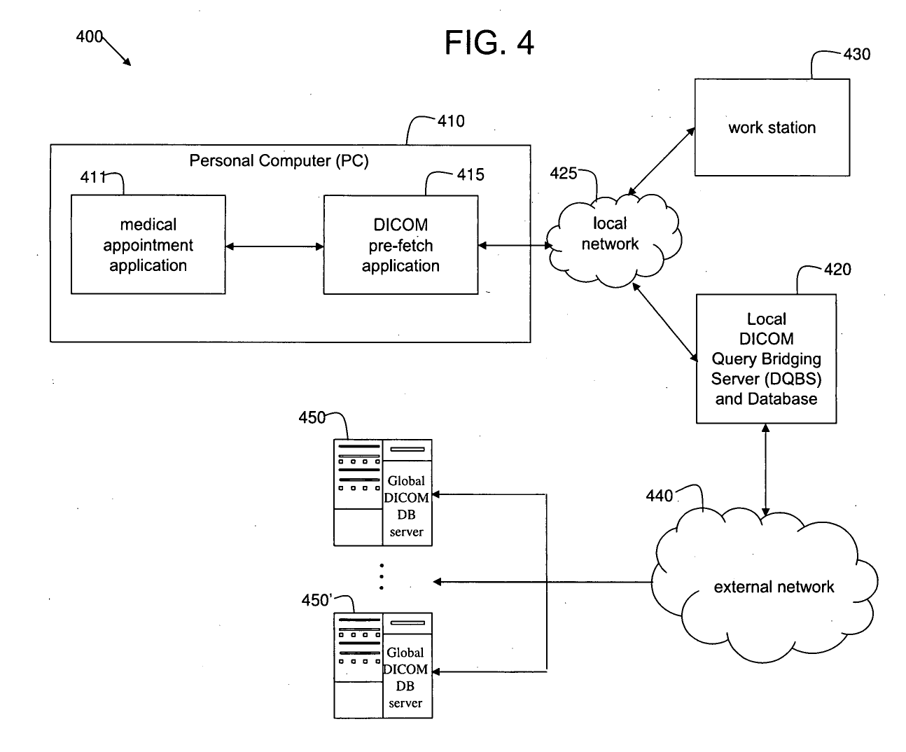

FIG. 4 illustrates a schematic diagram of a second exemplary embodiment of a system 400 for pre-fetching patient information using a DICOM protocol and a DQBS. The system 400 includes a personal computer 410 or equivalent processor-based platform. The system 400 includes a medical appointment software application 411 residing on the personal computer 410 (e.g., in a memory of the personal computer) for making patient appointments. For example, a medical administrative person working in a local medical office may enter patient appointment information into the medical appointment software application 411 when making an appointment for a patient. The patient appointment information may include, for example, a specified patient identification number, a specified appointment date and time, a specified date range, and a specified type of image information. Other information, including the patient's name, age, and sex may be entered as well, for example. The specified date range may correspond to a time interval over which a physician is interested, for example, in medical image information associated with the patient. The specified type of image information may correspond to, for example, a particular imaging modality such as one of ultrasound, MRI, X-ray, etc.

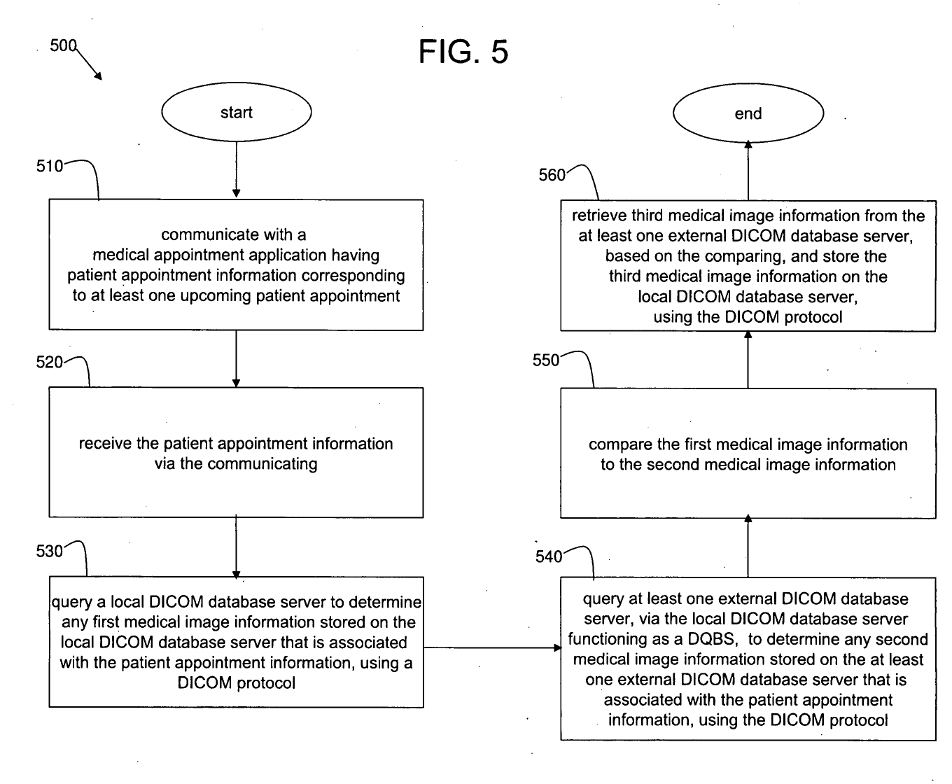

The system 400 also includes a DICOM pre-fetch software application 415 residing on the personal computer 410 (e.g., in a memory of the personal computer). The functionality provided by the DICOM pre-fetch software application 415 is described later herein with respect to the method 500 of FIG. 5. In general, however, the DICOM pre-fetch software application 415 retrieves patient appointment information ahead of time (i.e., before the scheduled patient appointment) from the medical appointment software application 411 and interacts with various DICOM database servers to retrieve desired medical image information associated with the patient such that the desired medical image information is locally available to the physician at the time of the scheduled patient appointment.

The medical appointment software application 411 may or may not be DICOM-compatible, in accordance with various embodiments of the present invention. If the medical appointment software application 411 is not DICOM compatible, then the DICOM pre-fetch software application 415 may have to be customized to communicate with the medical appointment software application 411. Otherwise, a standard DICOM protocol may be followed. When communicating with the medical appointment software application 411, the DICOM pre-fetch software application 415 may access an appointment database associated with the medical appointment software application 411.

In accordance with certain embodiments, to initiate communication between the medical appointment software application 411 and the DICOM pre-fetch software application 415, the DICOM pre-fetch software application 415 may query the medical appointment software application 411 for patient appointment information. Alternatively, the medical appointment software application 411 may initiate communication by pushing patient appointment information to the DICOM pre-fetch software application 415.

The system 400 also includes a local DICOM Query Bridging Server (DQBS) 420 operationally interfacing to the personal computer 410 via a local network 425 (e.g., a local area network). The system 400 further includes a work station 430 operationally interfacing to the local DQBS 420 via the local network 425. The work station 430 may be used by a physician or other user to readily call up and view images stored on the local DQBS 420, for example, during an appointment with a patient. The system also includes at least one external DICOM database server 450 operationally interfacing to the local DQBS 420 via an external network 440 (e.g., the Internet).

In accordance with an embodiment of the present invention, the DICOM pre-fetch software application 415 may be stored on a computer readable medium such as, for example, a compact disk (CD) for distribution. In accordance with other alternative embodiments of the present invention, the DICOM pre-fetch software application 415 may reside on another PC which operatively interfaces to the PC 410 via the local network 425, or may reside on the local DQBS 420, or on the work station 430, for example.

FIG. 5 illustrates a flowchart of a second exemplary embodiment of a method 500 for pre-fetching patient information using a DICOM protocol and the system 400 of FIG. 4. In step 510, communicate with a medical appointment application having patient appointment information corresponding to at least one upcoming patient appointment. In step 520, receive the patient appointment information via the communicating. In step 530, query a local DICOM database server to determine any first medical image information stored on the local DICOM database server that is associated with the patient appointment information, using a DICOM protocol. In step 540, query at least one external DICOM database server, via the local DICOM database server functioning as a DQBS, to determine any second medical image information stored on the at least one external DICOM database server that is associated with the patient appointment information, using the DICOM protocol. In step 550, compare the first medical image information to the second medical image information. In step 560, retrieve third medical image information from the at least one external DICOM database server, based on the comparing, and store the third medical image information on the local DICOM database server, using the DICOM protocol.

The following is an example of using the system 400 in accordance with the method 500. A radiologist may have previously archived MRI images (medical image information) of a particular patient (Ms. Smith) to a first global DICOM database server 450. Another radiologist may have previously archived PET (positron emission tomography) images (medical image information) of Ms. Smith to a second global DICOM database server 450′. The MRI images were archived on Sep. 7, 2007. The PET images were archived on Jan. 17, 2007. Furthermore, ultrasound images and PET images associated with the same patient were stored on the local DQBS 420 on Apr. 28, 2007.

The patient has an appointment scheduled in the medical appointment software application 411 for Nov. 14, 2007. On Nov. 3, 2007, the DICOM pre-fetch software application 415 automatically queries the medical appointment software application 411 for any upcoming patient appointments within the next two week and determines that Ms. Smith has an appointment scheduled for Nov. 14, 2007.

In order to prepare for the appointment of Ms. Smith, the DICOM pre-fetch software application 415 queries the local DQBS 420 to determine any first medical image information stored on the local DQBS 420 that is associated with Ms. Smith. As a result, the DICOM pre-fetch software application 415 finds the PET and ultrasound images that were stored to the local DQBS 420 on Apr. 28, 2007.

Next, the DICOM pre-fetch software application 415 sends a query to the local DQBS 420 via the local network 425. The query includes modality fields flagging MRI and PET modalities. The local DQBS 420 then forwards the query, via the external network 440, to the global DICOM database server 450 which is associated with the MRI modality, and to the global DICOM database server 450′ which is associated with the PET modality. The DQBS 420 is programmed to know which database server is associated with which modality.

As a result, the DQBS 420 finds the previously archived MRI and PET images associated with Ms. Smith that were archived to the global DICOM database servers 450 and 450′ on Sep. 7, 2007 and Jan. 17, 2007, respectively. As part of the query operations, the DICOM pre-fetch software application 415 may populate DICOM query fields with at least a portion of the patient appointment information.

The local DQBS 420 notifies the DICOM pre-fetch software application 415 of the existence of the MRI and PET images that are archived on the external DICOM database servers which are associated with Ms. Smith. The DICOM pre-fetch software application 415 then performs a comparison of the first medical image information stored on the local DICOM database server 420 and the second medical image information stored on the external DICOM database servers 450 and 450′ and determines that the PET images on the external DICOM database server 450′ are the same as the PET images stored on the local DQBS 420. The MRI images stored on the external DICOM database server 450 are not yet stored on the local DQBS 420.

The DICOM pre-fetch software application 415, as a result of the comparison, determines that the MRI images stored on the external DICOM database server 450 should be retrieved and stored to the local DQBS 420 such that the MRI images will be locally available to a physician via the work station 430 at the time of Ms. Smith's appointment. In this example, the third medical image information to be retrieved is the MRI images stored on the global DICOM database server 450.

The DICOM pre-fetch software application 415 may or may not immediately begin retrieving the third medical image information from the external DICOM database server 450 after the comparison. The DICOM pre-fetch software application 415 may be programmed to retrieve the third medical image information at a certain time of day (e.g., in the middle of the night). Alternatively, the DICOM pre-fetch software application 415 may determine a work load of the local DQBS 420 and/or a work load of the external DICOM database server 450 and wait until the work load is below some pre-defined level before beginning to retrieve the third medical image information.

If a date range is specified in the patient appointment information which includes the date of Sep. 7, 2007 on which the third medical image information of Ms. Smith was archived to the external DICOM database server 450, then the medical image information may be retrieved. However, if the specified date range does not include Sep. 7, 2007, then the medical image information may not be retrieved. Furthermore, if a type of medical image information is specified in the patient appointment information (e.g., MRI type), then only the MRI medical image information associated with Ms. Smith may be retrieved, and not any other type of medical image information which may also be associated with Ms. Smith (e.g., any new PET images).

When the appointment for Ms. Smith takes place on Nov. 14, 2007, the MRI medical image information retrieved from the external DICOM database server 450, as well as the PET and ultrasound medical image information previously stored on the local DQBS 420, are locally available for Ms. Smith's physician to access via the work station 430.

Sometime after the appointment of Ms. Smith is completed, the DICOM pre-fetch software application 415 may direct that, for example, the PET images and the ultrasound images be deleted from the local DQBS 420, thus keeping only the MRI images locally. All of the medical image information associated with Ms. Smith may still be archived on the various global DICOM database servers to be retrieved later, if desired.

Therefore, the DICOM pre-fetch software application 415 automatically interacts with the medical appointment software application 411 and the various external DICOM database servers via the local DQBS, in a manner that is transparent to any users, to ensure that desired medical image information is available locally to a physician at the time of a patient appointment.

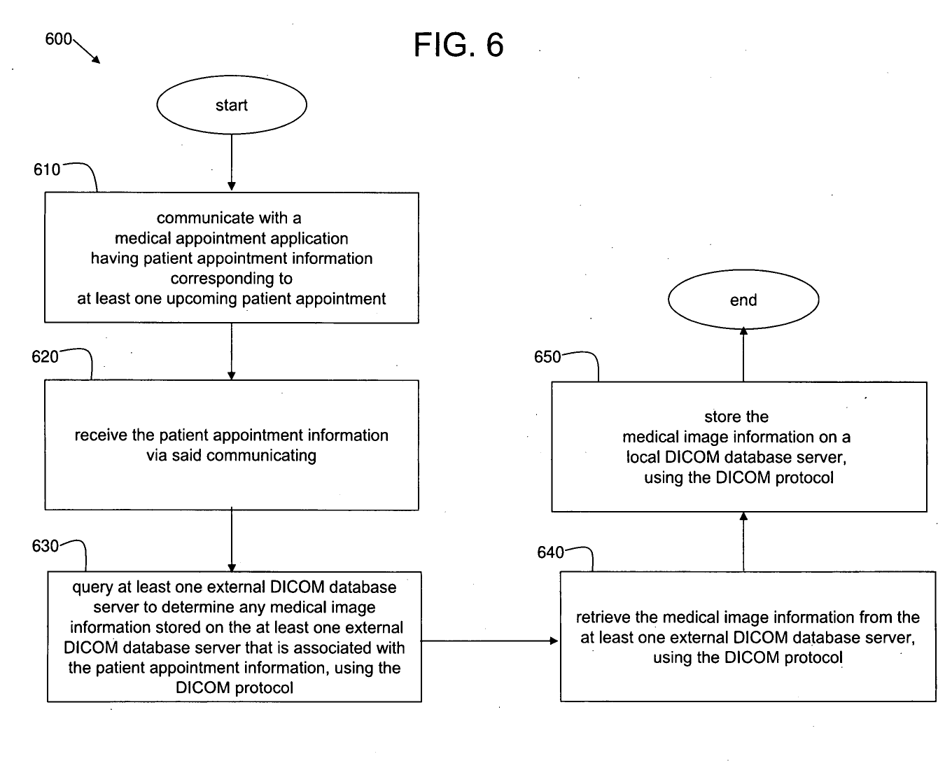

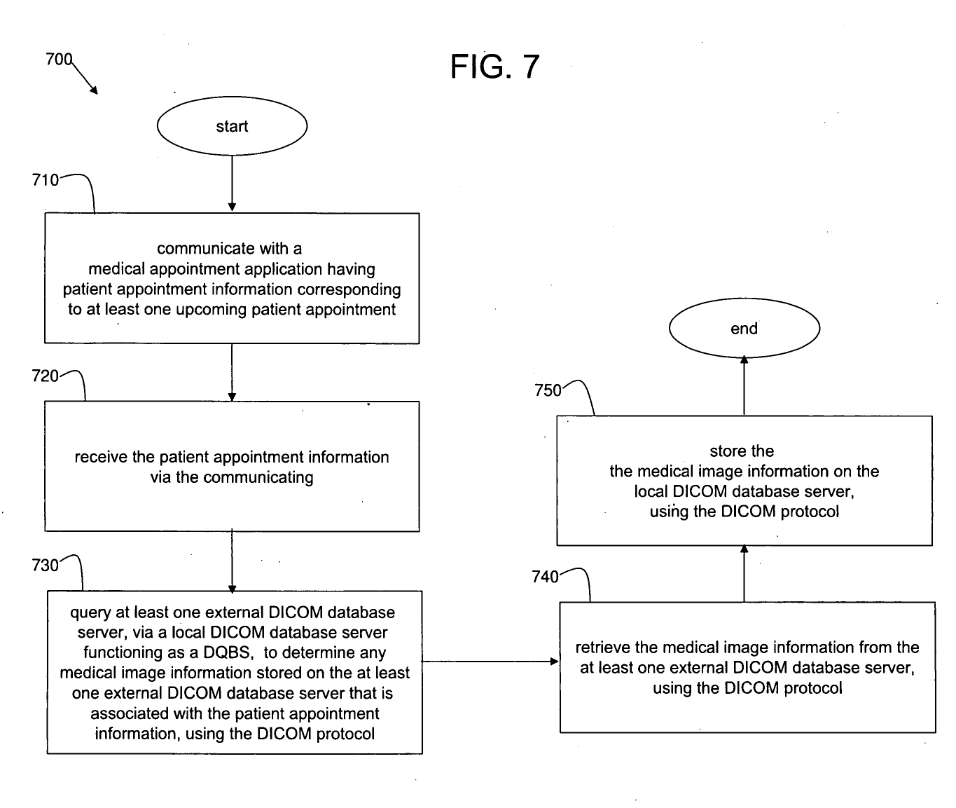

In accordance with certain alternative embodiments of the present invention, the DICOM pre-fetch software application may not query a local DICOM server to determine any first medical information stored on the local DICOM database server that is associated with the patient appointment information. Instead, the DICOM pre-fetch software application may simply query at least one external DICOM database server (directly or via a DQBS) to determine any medical image information stored on the at least one external DICOM database server that is associated with the patient appointment information. The DICOM pre-fetch software application may then retrieve that medical image information, without doing any comparing step, and store the medical image information on the local DICOM database server. Such embodiments, as shown in FIG. 6 and FIG. 7, are not concerned with comparing to patient medical image information previously stored on the local DICOM database server.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A method for pre-fetching patient information using a DICOM protocol, said method comprising:
(a) communicating with a medical appointment application having patient appointment information corresponding to at least one upcoming patient appointment;
(b) receiving said patient appointment information via said communicating;
(c) querying a local DICOM database server to determine any first medical image information stored on said local DICOM database server that is associated with said patient appointment information, using a DICOM protocol;
(d) querying at least one external DICOM database server to determine any second medical image information stored on said at least one external DICOM database server that is associated with said patient appointment information, using said DICOM protocol;
(e) comparing said first medical image information to said second medical image information; and
(f) retrieving third medical image information from said at least one external DICOM database server, based on said comparing, and storing said third medical image information on said local DICOM database server, using said DICOM protocol.

2. The method of claim 1 wherein said patient appointment information includes at least one of a specified patient identification number, a specified appointment date and time, a specified date range, a specified type of image information, and patient demographic information.

3. The method of claim 1 wherein said retrieving and storing of said third medical image information is further based on a time of day.

4. The method of claim 1 wherein said retrieving and storing of said third medical image information is further based on a work load of said local DICOM database server.

5. The method of claim 1 wherein said retrieving and storing of said third medical image information is further based on a work load of said at least one external DICOM database server.

6. The method of claim 1 wherein said retrieving and storing of said third medical image information is further based on an appointment date and time specified in said patient appointment information.

7. The method of claim 1 wherein said retrieving and storing of said third medical image information is further based on a date range specified in said patient appointment information.

8. The method of claim 1 wherein said retrieving and storing of said third medical image information is further based on a type of image information specified in said patient appointment information.

9. The method of claim 1 further comprising accessing at least a portion of said first medical image information and said third medical image information from said local DICOM database server via a workstation during said at least one patient appointment.

10. The method of claim 1 further comprising deleting said first medical image information and said third medical image information from said local DICOM database server after said at least one patient appointment has occurred.

11. The method of claim 1 wherein said method steps are performed by a DICOM pre-fetch software application residing on and operating on a personal computer.

12. The method of claim 1 wherein said step of querying a local DICOM database server and said step of querying at least one external DICOM database server is performed by a DICOM pre-fetch software application residing on and operating on a personal computer interfacing to said local DICOM database server via a local network and interfacing to said at least one external DICOM database server via an external network.

13. The method of claim 1 wherein said step of querying a local DICOM database server is performed by a DICOM pre-fetch software application residing on and operating on a personal computer interfacing to said local DICOM database server via a local network, and said step of querying at least one external DICOM database server is performed by said DICOM pre-fetch software application via said local DICOM database server functioning as a DICOM query bridging server (DQBS) and interfacing to said at least one external DICOM database server via an external network.

14. A computer readable medium having encoded thereon computer executable instructions for performing a method for pre-fetching patient information using a DICOM protocol, wherein said method comprises:
(a) communicating with a medical appointment application having patient appointment information corresponding to at least one upcoming patient appointment;
(b) receiving said patient appointment information via said communicating;
(c) querying a local DICOM database server to determine any first medical image information stored on said local DICOM database server that is associated with said patient appointment information, using a DICOM protocol;
(d) querying at least one external DICOM database server to determine any second medical image information stored on said at least one external DICOM database server that is associated with said patient appointment information, using said DICOM protocol;
(e) comparing said first medical image information to said second medical image information; and
(f) retrieving third medical image information from said at least one external DICOM database server, based on said comparing, and storing said third medical image information on said local DICOM database server, using said DICOM protocol.

15. The computer readable medium of claim 14 where said patient appointment information includes at least one of a specified patient identification number, a specified appointment date and time, a specified date range, a specified type of image information, and patient demographic information.

16. The computer readable medium of claim 14 where said retrieving and storing of said third medical image information is further based on a time of day.

17. The computer readable medium of claim 14 where said retrieving and storing of said third medical image information is further based on a work load of said local DICOM database server.

18. The computer readable medium of claim 14 where said retrieving and storing of said third medical image information is further based on a work load of said at least one external DICOM database server.

19. The computer readable medium of claim 14 where said retrieving and storing of said third medical image information is further based on an appointment date and time specified in said patient appointment information.

20. The computer readable medium of claim 14 where said retrieving and storing of said third medical image information is further based on a date range specified in said patient appointment information.

21. The computer readable medium of claim 14 where said retrieving and storing of said third medical image information is further based on a type of image information specified in said patient appointment information.

22. The computer readable medium of claim 14 where said method further comprises deleting said first medical image information and said third medical image information from said local DICOM database server after said at least one patient appointment has occurred.

23. A system for pre-fetching patient information using a DICOM protocol, said system comprising:
a personal computer;
a local DICOM database server operationally interfacing to said personal computer via a local network;
at least one external DICOM database server operationally interfacing to said personal computer via an external network; and
at least one work station operationally interfacing to said local DICOM database server via said local network,
wherein said personal computer includes a medical appointment software application for making patient appointments, and
wherein said personal computer includes a DICOM pre-fetch software application for:
(a) communicating with said medical appointment application having patient appointment information corresponding to at least one upcoming patient appointment;
(b) receiving said patient appointment information via said communicating;
(c) querying said local DICOM database server to determine any first medical image information stored on said local DICOM database server that is associated with said patient appointment information, using a DICOM protocol;
(d) querying said at least one external DICOM database server to determine any second medical image information stored on said at least one external DICOM database server that is associated with said patient appointment information, using said DICOM protocol;
(e) comparing said first medical image information to said second medical image information; and
(f) retrieving third medical image information from said at least one external DICOM database server, based on said comparing, and storing said third medical image information on said local DICOM database server, using said DICOM protocol.

24. A system for pre-fetching patient information using a DICOM protocol, said system comprising:
a personal computer;
a local DICOM database server operationally interfacing to said personal computer via a local network;
at least one external DICOM database server operationally interfacing to said local DICOM database server via an external network; and
at least one work station operationally interfacing to said local DICOM database server via said local network,
wherein said personal computer includes a medical appointment software application for making patient appointments, and
wherein said personal computer includes a DICOM pre-fetch software application for:
(a) communicating with said medical appointment application having patient appointment information corresponding to at least one upcoming patient appointment;
(b) receiving said patient appointment information via said communicating;
(c) querying said local DICOM database server to determine any first medical image information stored on said local DICOM database server that is associated with said patient appointment information, using a DICOM protocol;
(d) querying said at least one external DICOM database server, via said local DICOM database server functioning as a DQBS, to determine any second medical image information stored on said at least one external DICOM database server that is associated with said patient appointment information, using said DICOM protocol;
(e) comparing said first medical image information to said second medical image information; and
(f) retrieving third medical image information from said at least one external DICOM database server, based on said comparing, and storing said third medical image information on said local DICOM database server, using said DICOM protocol.

25. A method for pre-fetching patient information using a DICOM protocol, said method comprising:
(a) communicating with a medical appointment application having patient appointment information corresponding to at least one upcoming patient appointment;
(b) receiving said patient appointment information via said communicating;
(c) querying at least one external DICOM database server to determine any medical image information stored on said at least one external DICOM database server that is associated with said patient appointment information, using said DICOM protocol;
(d) retrieving said medical image information from said at least one external DICOM database server, using said DICOM protocol; and
(e) storing said medical image information on a local DICOM database server, using said DICOM protocol.

26. The method of claim 25 wherein said patient appointment information includes at least one of a specified patient identification number, a specified appointment date and time, a specified date range, a specified type of image information, and patient demographic information.

27. The method of claim 25 wherein said retrieving and storing of said medical image information is based on a time of day.

28. The method of claim 25 wherein said retrieving and storing of said medical image information is based on a work load of said local DICOM database server.

29. The method of claim 25 wherein said retrieving and storing of said medical image information is based on a work load of said at least one external DICOM database server.

30. The method of claim 25 wherein said retrieving and storing of said medical image information is based on an appointment date and time specified in said patient appointment information.

31. The method of claim 25 wherein said retrieving and storing of said medical image information is based on a date range specified in said patient appointment information.

32. The method of claim 25 wherein said retrieving and storing of said medical image information is based on a type of image information specified in said patient appointment information.

33. The method of claim 25 further comprising accessing at least a portion of said medical image information from said local DICOM database server via a workstation during said at least one patient appointment.

34. The method of claim 25 further comprising deleting said medical image information from said local DICOM database server after said at least one patient appointment has occurred.

35. The method of claim 25 wherein said method steps are performed by a DICOM pre-fetch software application residing on and operating on a personal computer.

36. The method of claim 25 wherein said step of querying at least one external DICOM database server is performed by a DICOM pre-fetch software application residing on and operating on a personal computer interfacing to said local DICOM database server via a local network and interfacing to said at least one external DICOM database server via an external network.

37. The method of claim 25 wherein said step of querying at least one external DICOM database server is performed by a DICOM pre-fetch software application via said local DICOM database server functioning as a DICOM query bridging server (DQBS) and interfacing to said at least one external DICOM database server via an external network.

38. A computer readable medium having encoded thereon computer executable instructions for performing a method for pre-fetching patient information using a DICOM protocol, wherein said method comprises:
(a) communicating with a medical appointment application having patient appointment information corresponding to at least one upcoming patient appointment;
(b) receiving said patient appointment information via said communicating;
(c) querying at least one external DICOM database server to determine any medical image information stored on said at least one external DICOM database server that is associated with said patient appointment information, using said DICOM protocol;
(d) retrieving said medical image information from said at least one external DICOM database server, using said DICOM protocol; and
(e) storing said medical image information on a local DICOM database server, using said DICOM protocol.

39. The computer readable medium of claim 38 where said patient appointment information includes at least one of a specified patient identification number, a specified appointment date and time, a specified date range, a specified type of image information, and patient demographic information.

40. The computer readable medium of claim 38 where said retrieving and storing of said medical image information is based on a time of day.

41. The computer readable medium of claim 38 where said retrieving and storing of said medical image information is based on a work load of said local DICOM database server.

42. The computer readable medium of claim 38 where said retrieving and storing of said medical image information is based on a work load of said at least one external DICOM database server.

43. The computer readable medium of claim 38 where said retrieving and storing of said medical image information is based on an appointment date and time specified in said patient appointment information.

44. The computer readable medium of claim 38 where said retrieving and storing of said medical image information is based on a date range specified in said patient appointment information.

45. The computer readable medium of claim 38 where said retrieving and storing of said medical image information is based on a type of image information specified in said patient appointment information.

46. The computer readable medium of claim 38 where said method further comprises deleting said medical image information from said local DICOM database server after said at least one patient appointment has occurred.

47. A system for pre-fetching patient information using a DICOM protocol, said system comprising:
a personal computer;
a local DICOM database server operationally interfacing to said personal computer via a local network;
at least one external DICOM database server operationally interfacing to said personal computer via an external network; and
at least one work station operationally interfacing to said local DICOM database server via said local network,
wherein said personal computer includes a medical appointment software application for making patient appointments, and
wherein said personal computer includes a DICOM pre-fetch software application for:
(a) communicating with said medical appointment application having patient appointment information corresponding to at least one upcoming patient appointment;
(b) receiving said patient appointment information via said communicating;
(c) querying said at least one external DICOM database server to determine any medical image information stored on said at least one external DICOM database server that is associated with said patient appointment information, using said DICOM protocol;
(d) retrieving said medical image information from said at least one external DICOM database server, using said DICOM protocol; and
(e) storing said medical image information on said local DICOM database server, using said DICOM protocol.

48. A system for pre-fetching patient information using a DICOM protocol, said system comprising:
a personal computer;
a local DICOM database server operationally interfacing to said personal computer via a local network;
at least one external DICOM database server operationally interfacing to said local DICOM database server via an external network; and
at least one work station operationally interfacing to said local DICOM database server via said local network,
wherein said personal computer includes a medical appointment software application for making patient appointments, and
wherein said personal computer includes a DICOM pre-fetch software application for:
(a) communicating with said medical appointment application having patient appointment information corresponding to at least one upcoming patient appointment;
(b) receiving said patient appointment information via said communicating;
(c) querying said at least one external DICOM database server, via said local DICOM database server functioning as a DQBS, to determine any medical image information stored on said at least one external DICOM database server that is associated with said patient appointment information, using said DICOM protocol;
(d) retrieving said medical image information from said at least one external DICOM database server, using said DICOM protocol; and
(e) storing said medical image information on said local DICOM database server, using said DICOM protocol.
